(19) United States
(12) Patent Application Publication
(10) Pub. No.: US 2001/0026434 A1
(43) Pub. Date: Oct. 4, 2001

(54) Configuration for connecting power semiconductor chips in modules

(76) Inventor: Manfred Loddenkoetter, Ibbenburen (DE)

Correspondence Address: LERNER AND GREENBERG, P.A., Post Office Box 2480, Hollywood, FL, 33020-2480, US

(21) Appl. No.: 09/803,759

(22) Filed: Mar. 12, 2001

(30) Foreign Application Priority Data
Mar. 10, 2000 (DE) 100 11 633.7

(51) Int. Cl. H01H 47/18

(52) U.S. Cl. 361/200

(57) ABSTRACT

A configuration for connecting power semiconductor chips in modules is configured such that the power semiconductor chips are positioned in a chessboard pattern and in each case a respective function type of the power semiconductor chips is assigned to a respective “color” of the fields of the chessboard pattern.

### BACKGROUND OF THE INVENTION

### Field of the Invention

The invention relates to a power semiconductor configuration and relates in particular to a configuration for connecting power semiconductor chips in modules, wherein the power semiconductor chips are assigned at least two different function types and are mounted, via ceramic substrates, on a common baseplate.

Electronic components, in particular IGBT (Insulated Gate Bipolar Transistor) chips and diode chips, may be connected to one another in power semiconductor modules. Apart from IGBT chips and diode chips, other electronic components can also be used in such power semiconductor modules. Examples are power transistors, thyristors and so on.

If it is necessary to process high power values in such a power semiconductor module, a number of power semiconductor chips can be connected in parallel with one another internally. However, specifically with such a parallel connection various problems occur which will be explored in more detail below:

Power semiconductor chips which are located spatially closely one next to the other or which are adjacent influence one another thermally, which leads to an uncontrolled heating of the module and makes it difficult to conduct away heat or cool the module.

Local thermal peaks, which occur specifically in asymmetrical configurations of the individual power semiconductor chips, can lead to static and dynamic incorrect apportionments or an incorrect distribution of currents in the module and may also result in oscillation phenomena.

Finally, expanding the function of a module gives rise to problems if, for example, a basic function which is carried out by a plurality of individual power semiconductor chips is to be modified; this means that the flexibility of the module is limited.

In order to avoid or circumvent the above-mentioned problems, the approach has hitherto been to provide the individual power semiconductor chips directly one next to the other but at the same time to subject them to less thermal stressing, which, however, makes complex cooling systems necessary. Another possibility is to integrate only a small number of power semiconductor chips in one module, that is to say to tolerate larger space requirements. Furthermore, incorrect apportionments or distribution of currents or oscillation phenomena may be unavoidable. Finally, expanding the function or changing the basic function are possible if the layout of the module is accordingly fundamentally changed. However, this is virtually equivalent to the task of having to redesign the entire module.

Until now there has been no satisfactory solution to the problems indicated above.

### SUMMARY OF THE INVENTION

It is accordingly an object of the invention to provide a power semiconductor configuration which overcomes the above-mentioned disadvantages of the heretofore-known configurations of this general type and in which thermal influences of the power semiconductor chips on one another are largely eliminated so that no static or dynamic incorrect distribution of currents occurs, and in which functions of the configuration can be expanded without fundamentally changing the layout of the modules in the configuration.

With the foregoing and other objects in view there is provided, in accordance with the invention, a power semiconductor configuration, including:

a common base plate;

a plurality of ceramic direct-copper-bond substrates disposed on the common base plate;

a plurality of power semiconductor chips including at least first power semiconductor chips of a first functional type and second power semiconductor chips of a second functional type, the power semiconductor chips being connected to form modules;

the power semiconductor chips being disposed on respective ones of the ceramic direct-copper-bond substrates;

the power semiconductor chips defining a chessboard pattern with alternating first and second regions, the first power semiconductor chips being disposed substantially only in the first regions, the second power semiconductor chips being disposed substantially only in the second regions; and

a bus system disposed symmetrically in the chessboard pattern.

In other words, the object of the invention is achieved with a configuration for connecting power semiconductor chips in modules, wherein the power semiconductor chips are assigned at least two different function types and are mounted, via ceramic substrates, on a common baseplate, and wherein the power semiconductor chips are disposed in the manner of a chessboard pattern and as far as possible identical function types occupy fields of the “same color” of the chessboard pattern.

In the configuration according to the invention, for example, IGBT power semiconductor chips and diode power semiconductor chips are provided in the manner of a chessboard pattern on the individual substrates and are provided altogether on the baseplate in the module. In this configuration, power semiconductor chips of the same function types occupy in each case fields of the “same color” of the chessboard pattern. In other words, IGBT power semiconductor chips are provided, for example, on “black” fields while diode power semiconductor chips are assigned to the “white” fields.

As a result of this measure, the thermal expansion zones or thermal propagation zones of the individual power semiconductor chips overlap only to a minimum degree. In addition, use is advantageously made of the fact that power semiconductor chips with a different function, that is to say for example IGBT power semiconductor chips and diode power semiconductor chips, do not experience their greatest degree of heating at the same time in the different operating states of the module, with the result that even a possible overlapping of the thermal expansion zones does not result in negative effects.

According to another feature of the invention, each of the modules has basic functions implemented on a respective one of the ceramic direct-copper-bond substrates.

The implementation of an electrical basic function as a half bridge on just one substrate, in particular a DCB substrate, leads to a spatial separation of power semiconductor chips connected in parallel on adjacent substrates, so that here too no overlapping of thermal expansion zones is to be expected.

The already mentioned implementation of an electrical basic function as a half bridge on a substrate makes it possible to have, through appropriate structuring of a bus system, a symmetrical parallel connection of the basic functions using bonding wires. This symmetrical configuration whose symmetry also applies to further lines, in particular control lines, is applied in a repeatedly duplicated manner in the module.

Because the basic function is ultimately implemented on one substrate, a substrate which is connected in parallel can be replaced by another function without having to reconfigure the basic configuration of the module or change it. This flexibility is further increased by the already mentioned symmetry of the bus system.

Other features which are considered as characteristic for the invention are set forth in the appended claims.

Although the invention is illustrated and described herein as embodied in a configuration for connecting power semiconductor chips in modules, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic top plan view of a module of a configuration according to the invention; and

FIG. 2 is a schematic block diagram for illustrating a detail of the module shown in FIG. 1.

### DESCRIPTION OF THE PREFERRED EMBODIMENTS

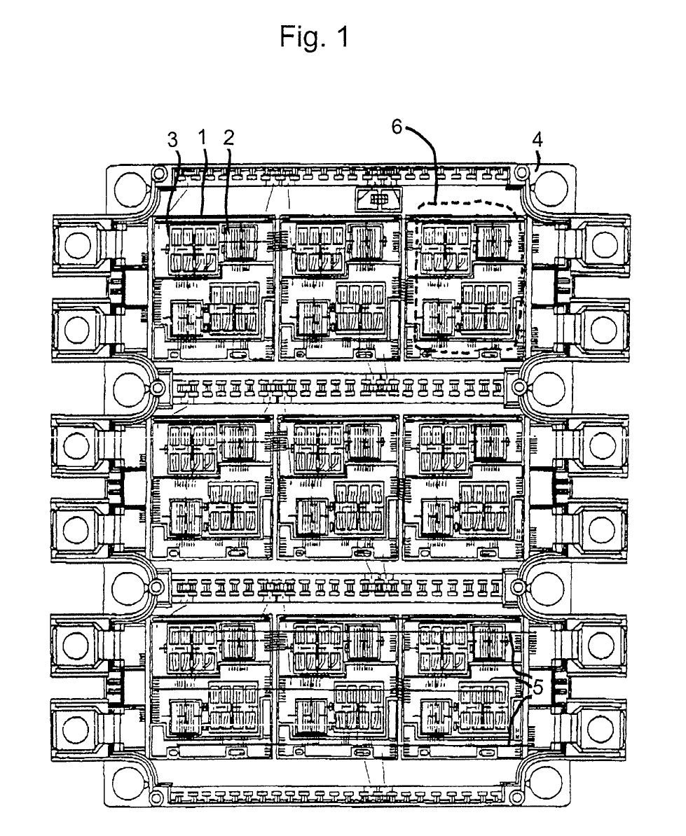

Referring now to the figures of the drawings in detail and first, particularly, to FIG. 1 thereof, there is shown how in a module, individual power semiconductor chips in the form of IGBT chips 1 and diode chips 2 are mounted on a baseplate 4 through the use of substrates 3 and at the same time provided in the manner of a chessboard pattern. DCB structures (DCB=Direct Copper Bond) are preferably used here for the substrates 3.

In such power semiconductor modules, the power semiconductor chips 1, 2 may be soldered onto ceramic substrates 3 such as DCB substrates, which are “sandwich substrates” having a copper-ceramic-copper structure. The ceramic substrates 3 themselves are preferably soldered to a baseplate 4.

In such a configuration, the ceramic substrate, that is to say in particular the DCB substrate 3, performs the function of providing electrical insulation and thermal conduction of the heat generated in the power semiconductor chip. In addition, the ceramic substrate contains structures which, in conjunction with bonded wires, realize the electrical function of the power semiconductor chip.

The baseplate 4 has a mechanical function and serves as a carrier. The baseplate 4 also has a thermal function and serves as a heat conductor to a heat sink or cooling device which is additionally provided if appropriate and onto which the power semiconductor module is attached with screws or the like.

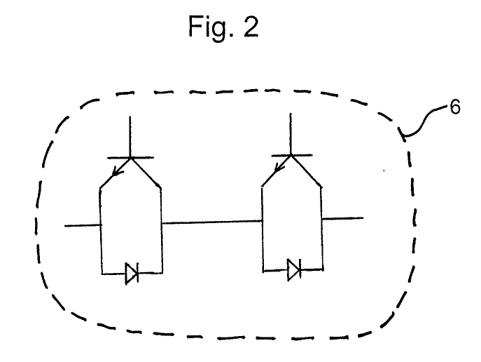

Electrical basic functions are implemented as half bridges 6 on the substrates 3 and connected in parallel with one another through the use of a bus system 5 and corresponding bonding wires. In order to simplify the illustration, in each case just one bus system 5 and one half bridge 6 are specifically indicated. The half bridge 6 is circled by a dashed line in FIG. 1. FIG. 2 is a schematic block diagram illustrating the half bridge of the module shown in FIG. 1. The exemplary half bridge is represented by transistors and diodes.

As a result of the chessboard pattern-like configuration of the individual power semiconductor chips, overlapping of thermal expansion zones or thermal propagation zones is only minimal. In addition, use is advantageously made of the fact that power semiconductor chips with a respectively different function, that is to say the IGBT chips 1 and the diode chips 2, do not experience their greatest degree of heating at the same time in the different operating states of the module, with the result that the staggered timing of the overlapping (i.e. time-shifted overlapping) of the thermal expansion zones has no negative effects.

An essential feature of the invention is therefore the chessboard pattern-like configuration of, for example, IGBT chips and diode chips in a module, where functionally identical chips occupy fields of the “same color” in each case. In such a configuration of the various chips in a chessboard pattern the bus structure can readily be made to extend linearly along the individual chips. Electrical basic functions can be readily implemented on individual substrates, as a result of which an expansion through the use of identical substrates is possible in order to achieve an increase in power through the use of parallel connection. Likewise, an expansion through the use of different substrates can be performed in order to implement an overall change in the function of the module.

Thus, for example individual substrates can be replaced by current measuring resistors. In this way, supplementary functions, that is to say current measurements in, for example, linearly extending phase lines are possible. Likewise, rectifier input bridges, for example, instead of individual substrates can also be installed in the module.

I claim:

1. A power semiconductor configuration, comprising:
a common base plate;
a plurality of ceramic direct-copper-bond substrates disposed on said common base plate;
a plurality of power semiconductor chips including at least first power semiconductor chips of a first functional type and second power semiconductor chips of a second functional type, said power semiconductor chips being connected to form modules;
said power semiconductor chips being disposed on respective ones of said ceramic direct-copper-bond substrates;
said power semiconductor chips defining a chessboard pattern with alternating first and second regions, said first power semiconductor chips being disposed substantially only in the first regions, said second power semiconductor chips being disposed substantially only in the second regions; and
a bus system disposed symmetrically in the chessboard pattern.

2. The power semiconductor configuration according to claim 1, wherein:
said first power semiconductor chips are insulated gate bipolar transistors; and
said second power semiconductor chips are power diodes.

3. The power semiconductor configuration according to claim 1, wherein each of said modules has basic functions implemented on a respective one of said ceramic direct-copper-bond substrates.

4. The power semiconductor configuration according to claim 2, wherein each of said modules has basic functions implemented on a respective one of said ceramic direct-copper-bond substrates.
